(19) United States
(12) Patent Application Publication
(10) Pub. No.: US 2022/0366345 A1
(43) Pub. Date: Nov. 17, 2022

(54) PERFORMANCE EVALUATION SYSTEMS AND METHODS

(71) Applicant: The Initiative for Advancing the Blue & Black Partnership LLC, Potomac, MD (US)

(72) Inventors: Nadine Jones, Jersey City, NJ (US); Ama Romaine, Potomac, MD (US)

(21) Appl. No.: 17/742,907

(22) Filed: May 12, 2022

Related U.S. Application Data
(60) Provisional application No. 63/188,964, filed on May 14, 2021.

(51) Int. Cl. G06Q 10/06; G06Q 50/26

(52) U.S. Cl. CPC G06Q 10/06393; G06Q 50/265

(57) ABSTRACT

In some embodiments, systems and methods are provided herein for collecting and analyzing data to evaluate the performance of an institution or organization, such as a police agency or other community organization. The institution performance evaluation system may include data collection tools that collect data relevant to institutional performance using electronic questionnaires. The electronic questionnaires may prompt a user to input information related to the institution's community engagement, training, and organizational development. In addition, the data collection tools may leverage one or more databases to gather data related institutional or community performance. Using an analytics engine, the system analyzes collected data and assigns performance scores to the institution. Based on the institution's performance scores, the system automatically generates corrective actions for improved performance.

### TECHNICAL FIELD

This invention relates generally to collecting and analyzing data to assist with improving, for example, assessments of organizational performance, systemic training, and community policing.

### BACKGROUND

While there are many theories and tools for improving organizational performance (e.g., benchmarking, educational initiatives, top-down or bottom-up approaches), leaders for certain types of institutions or organizations are limited by the lack of easily quantifiable goals and progress related thereto. Further, community-centric institutions or organizations may lack a formal framework for measuring and assessing the effectiveness of the organization's performance while also tracking goals and progress of the community the institution or organization serves. While this may be true in many different areas such as the arts, non-profit organizations, and/or community institutions, among many other, these limitations are associated with particular negative outcomes for law enforcement agencies. This may be exacerbated by a lack of consistent data gathering practices in law enforcement agencies. There remains a desire for systematic approaches for performance assessment that track and measure organizational improvements over time.

Such challenges may be encountered, for example, in law enforcement agencies seeking to implement community-oriented policing strategies or trying to understand how its performance or effectiveness compares to other agencies. Community-oriented policing is a philosophy of policing whereby a police agency organizes itself, trains its officers, and implements policies that facilitate the collaborative and proactive engagement between officers and the communities they serve. Police agencies that effectively incorporate community policing may improve the level of trust among members of the community and also positively impact crime rates. However, information that is indicative of a police agency's ability to engage in community-oriented policing—such as information related the agency's community engagement, officer training, and organizational development—may not be readily available or easily quantifiable. Further, there may be a desire to keep such agency information confidential to others outside of the police agency.

Therefore, there remains a desire to have an evaluation system for institutions, such as police agencies, that is both diagnostic and prescriptive; that is, that enables an agency to measure and visualize policing performance while also automatically generating recommendations to improve performance. There also remains a desire to have a policing performance evaluation system that provides a streamlined data collection process to mine a number of data sources in order to measure an agency's readiness to engage in community-oriented policing in a confidential manner. In addition, there remains a desire to assess the needs of a community as it grows and changes in a more real-time manner.

### BRIEF DESCRIPTION OF THE DRAWINGS

FIG. 1 is schematic diagram of an institution performance analysis system, in accordance with some embodiments.

FIGS. 2A and 2B are schematic diagrams of exemplary database structures for the institution performance analysis system.

FIG. 3 is a process flow diagram of an exemplary method of operating an institution performance evaluation system of FIG. 1 to evaluate performance of a police agency.

FIG. 4 is a process flow diagram of an exemplary method of operating the institution performance analysis system of FIG. 1.

FIG. 5 is a process flow diagram of an exemplary method of operating the institution performance analysis system of FIG. 1.

FIG. 6 is an exemplary user interface employed by the agency evaluation module in accordance with some embodiments.

FIG. 7 is another exemplary user interface employed by the agency evaluation module in accordance with some embodiments.

FIG. 8 is another exemplary user interface employed by the agency evaluation module in accordance with some embodiments.

FIG. 9 is a process flow diagram of an exemplary method of operating institution performance evaluation system of FIG. 1 to evaluate a community.

FIG. 10 a process flow diagram of another exemplary method of operating institution performance evaluation system of FIG. 1 to evaluate a community.

FIG. 11 is an exemplary user interface employed by the community evaluation module in accordance with some embodiments

FIG. 12 is another exemplary user interface employed by the community evaluation module in accordance with some embodiments

FIG. 13 is another exemplary user interface employed by the community evaluation module in accordance with some embodiments

FIGS. 14A and 14B are schematic diagrams of another exemplary institution performance analysis system, in accordance with some embodiments

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Provided herein are systems and methods for collecting and analyzing data to evaluate the performance of an institution or organization, such as a police agency or other community organization. As described herein, an institution performance evaluation system may include data collection tools that collect data relevant to institutional performance. The data collection tools may transmit, and receive input in response to, electronic questionnaires. The electronic questionnaires may prompt a user to input information related to the institution's community engagement, training, and organizational development. In addition, the data collection tools may leverage one or more databases to gather data that enables the system to gauge institutional performance. Such data may include, for example, incident data and statistical data relating to various institutional performance metrics. Using an analytics engine, the system analyzes collected data and assigns scores to the institution based on data related to the agency's community engagement, training, and organizational development. Further, the system may analyze the collected data to establish institutional performance benchmarks, by which the performance of an institution may be measured. Based on the institution's performance, in some embodiments, the system automatically generates corrective actions for improved performance.

It is contemplated that the systems and methods described herein may be used to evaluate any institution, organization, or agency. In some embodiments, the system and methods may be employed to evaluate any form of local, state, or federal police or law enforcement department, precinct, or agency. Other examples of institutions include hospitals, educational institutions, religious organizations, prosecutors' offices, and courts.

In some aspects, the systems and methods provided herein may also be employed to collect and analyze data to evaluate a community associated with the institution, organization, or agency. The community evaluation system may employ data collection tools that collect data relevant to community safety and wellbeing. The data collection tools may transmit, and receive input in response to, electronic questionnaires. The electronic questionnaires, for example, may prompt a user to input information related to public safety, physical health, mental health, economic opportunities, and educational opportunities. In addition, the data collection tools may leverage one or more databases to gather data that enables the system to gauge community safety and wellbeing. Such data may include data related to community safety and wellbeing indicators such as life expectancy, violent crime rates, mental illness rates, and median income. Using an analytics engine, the system analyzes collected data to assign scores to the community based on data related to the community's safety and wellbeing indicators. Further, the system may analyze the collected data to establish community safety and wellbeing benchmarks, by which the safety and wellbeing or performance of a community may be measured.

The institution evaluation system and community evaluation system may be in communication with each other. The community evaluation system may be used to collect and analyze data external to the institution while the institution evaluation system may be used to collect and analyze data internal to the organization. In this manner, the systems may analyze the institution itself and its impact or perception in the community it is associated with in real time. Together, this combined analysis provides organizations with a particularly effective manner of evaluating performance and correlating outcomes with institutional efforts. These performance evaluation systems also compare agencies against each other in an aggregated manner.

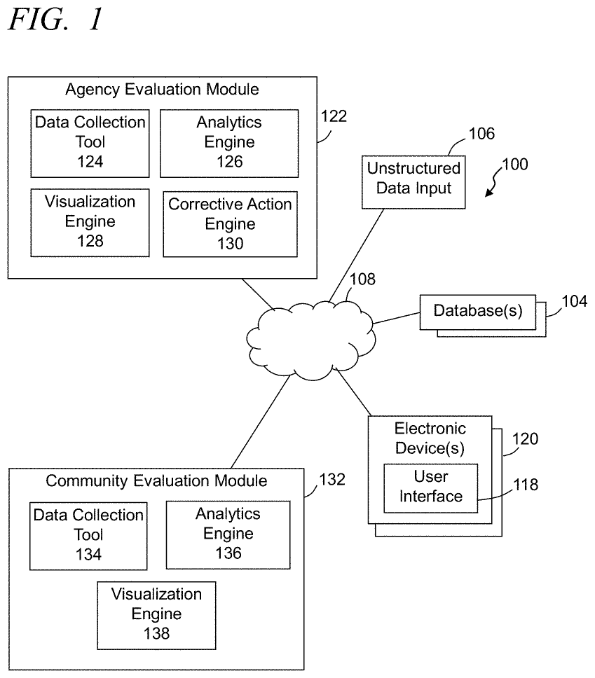

With reference to FIG. 1, an institution performance evaluation system 100 is illustrated showing various components of the system 100. The system 100 may be employed to collect data related to the performance of an institution, such as a policing agency. Such data may represent any information that is probative, for example, of the institution's community engagement, training such as officer training, and organizational development. Further, the system 100 may process and analyze collected data to evaluate the performance of an institution and automatically generate suggested corrective actions to improve performance. In some embodiments, the system 100 may be employed to evaluate and generate corrective actions for a police or law enforcement agency. In other embodiments, the system 100 may be employed to evaluate and generate corrective actions for an educational institution or a hospital.

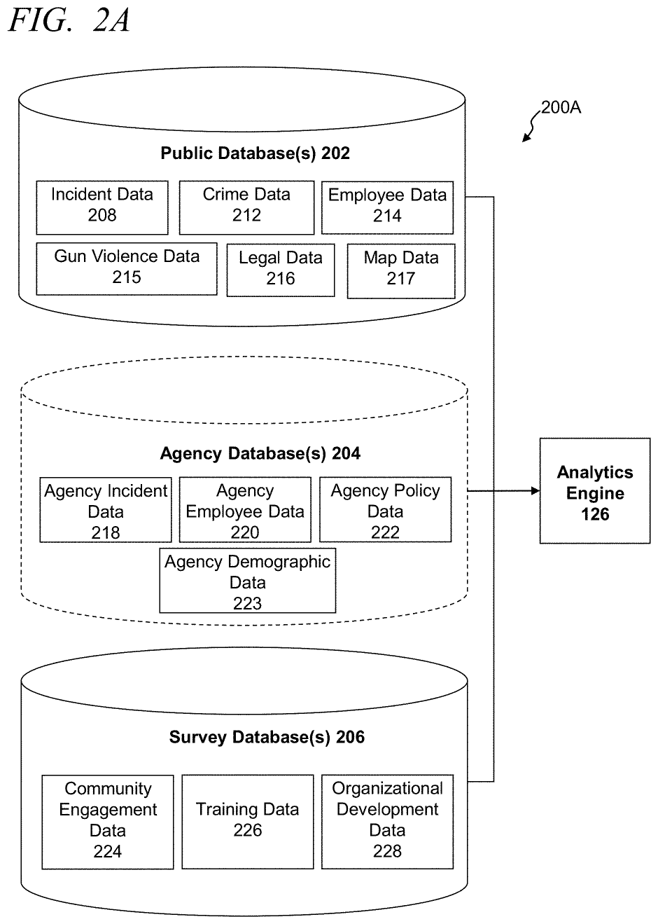

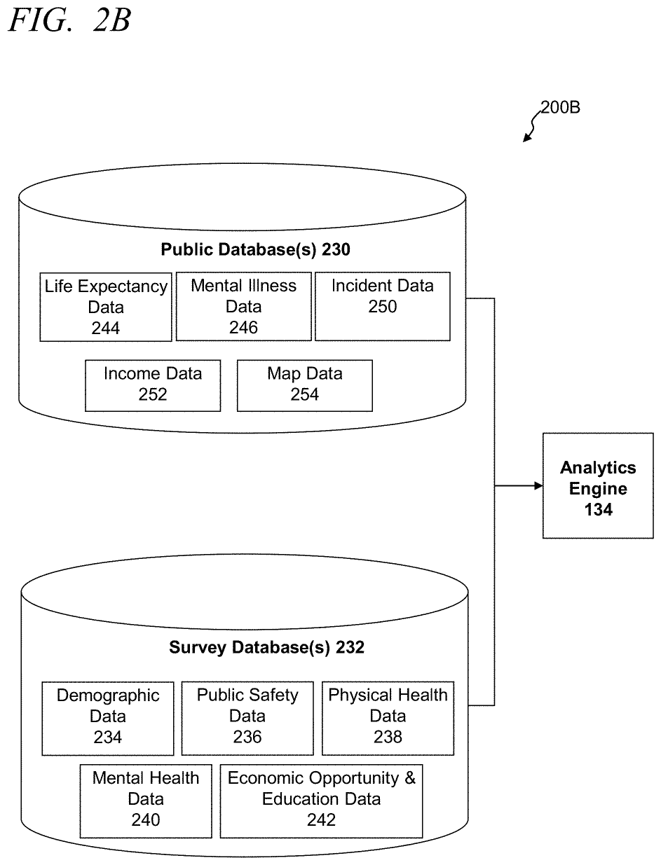

The system 100 includes various data inputs. The data inputs include one or more databases 104 and unstructured data inputs 106. Exemplary structures for the databases 104 that may be part of or in communication with the system 100 is illustrated in FIGS. 2A and 2B. The unstructured data inputs 106 may include any unstructured textual, image, video, or audio data such as maps, officer reports, institutional documents, legal documents, personnel files, leadership reports, institutional records, agency incident reports, 911-call recordings, social media posts, news publications, body camera recordings, written responses to questionnaires, etc. It is also contemplated that the system 100 may be configured to parse or otherwise add structure to data from the unstructured data inputs 106 and, once structured, store data in one or more of the databases 104.

The system 100 further includes one or more electronic device(s) 120. The electronic device 120 may be a tablet, smart phone, laptop, personal computer, smart watch, and any other suitable electronic device. One or more user interfaces 118 may be associated with the electronic device 120. The user interfaces 118 may be used for user input and/or for output display. For example, the user interface may include any known input devices, such one or more buttons, knobs, selectors, switches, keys, touch input surfaces, audio input, and/or displays, etc. The user interfaces 118 may further include lights, visual indicators, display screens, etc. to convey information to a user, such as but not limited to the communication of: questions, requests for information, messages, notifications, recommendations, training modules, notifications, alerts, reports, instructions, prompts, surveys, instructions, other information generated by the system 100.

In some embodiments, a user may use one or more electronic devices 120 to complete an institutional performance questionnaire or a community safety and wellbeing questionnaire. For example, the user may input responses to a series of questions via the user interface 118 associated with the electronic device 120.

The system 100 may also include modules for the collection and analysis of data relevant to institutional performance and/or community safety and wellbeing and/or perception. In some approaches, system 100 includes one or more of an agency evaluation module 122 and a community evaluation module 130.

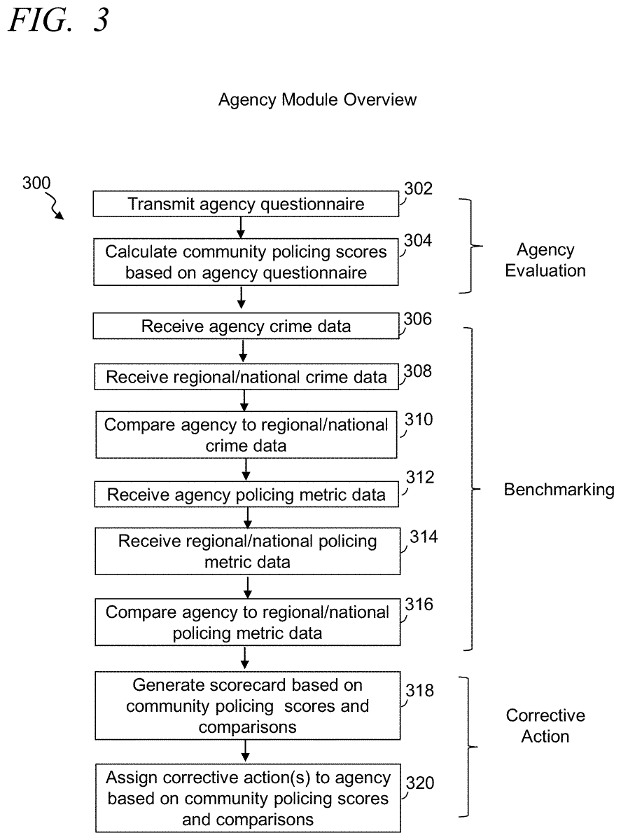

The agency evaluation module 122 includes a data collection tool 124, an analytics engine 126, a visualization engine 128, and a corrective action engine 130. The agency evaluation module 122, and any components thereof, may be in communication with the databases 104, unstructured data input 106, and the electronic devices 120. In this manner, the evaluation module 122 may receive data from any one of these various data sources. In some embodiments, the agency evaluation module 122 may be used to implement the methods illustrated with reference to FIGS. 3-6.

The data collection tool 124 may be configured to collect information or data relevant to the assessment of an institution, such as police agency or other community organization. In some approaches, the data collection tool 124 may be configured to transmit one or more electronic surveys or questionnaires to an electronic device 120 associated with a primary or principal user. The principal user may be, for example, a leader, officer, manager, chief, dispatcher, or other employee associated with the institution. The questionnaires may include one or more questions, prompts, or requests for information for the principal user relevant to the assessment of institutional performance. In some embodiments, when the system is used to evaluate a police agency, the questions, prompts, or requests for information may be relate or be probative of the agency's ability to engage in community-oriented policing. In response to transmitting the electronic surveys or questionnaires, the data collection tool 124 may receive information or data relevant to the assessment of the institution. For example, the principal user may input information related the queries, prompts, or requests for information via the user interface 118 associated with the electronic user device 120. The data collection tool 124 may be in communication with one or more databases 104 and may store information or data received in response to the electronic questionnaires in the databases 104.

The data collection tool 124 may also be configured to query or otherwise receive data from one or more databases 104 in order to gather data such as crime data or other data indicative of one or more policing metrics. In some approaches, the data collection tool 124 may receive data from one or more databases 104 in real time. In other approaches, the data collection tool 124 may receive data from one or more databases 104 periodically, for example, daily, weekly, monthly, or annually. While shown as part of the system 100, it is also contemplated that one or more databases may be external to the system 100, for example, public or third-party databases that are accessible by the system 100.

In some embodiments, the data collection tool 124 may also facilitate the creation of a confidential account for an institution or a user associated with the institution to ensure data collection remains confidential. Account creation may include an authentication and registration process for a new user associated with an institution. In the authentication process, a user may be prompted to enter an institution email address and to provide institutional details so that the identity of the institutional use can be validated. In one example, when the principal user is a police chief or officer associated with a police agency, the authentication process may prompt the user to enter the police department email address, agency type, state name, and precinct name. Such information may be used to validate the identity of the police chief prior to or as part of account creation.

As part of the account creation, the data collection tool 124 may create or receive a user identifier associated with the particular user or the particular institution. For example, the user may create a user identifier such as a login and password that the user may use to access the account via an electronic device. In another example, the user identifier may be automatically read from some piece of media, for instance smartcard or keycard. The user identifier may, for example, be encoded in a magnetic stripe, machine-readable symbol, or wireless transponder (e.g., RFID transponder) of the smartcard or keycard. In this manner, the data collection tool 124 may associate collected data with the user identifier and may limit access to collected data to users associated with the user identifier.

The analytics engine 126 analyzes data that is relevant to the performance of an institution to assign a performance score to the institution. In some embodiments, the analytics engine 126 analyzes data that is relevant to the performance of a police agency in order to evaluate the police agency and assign a community policing score or policing performance score to the police agency. In some approaches, the analytics engine 126 receives data, either directly or indirectly, from the data collection tool 124. In other approaches, the analytics engine 126 may also receive data directly from the databases 104, unstructured data inputs 106, or electronic devices 120. After receiving relevant data, the analytics engine 126 weighs the data to assign a performance score. In one example, the performance scores may be assigned for various performance areas such as community engagement, training, and organizational development.

The analytics engine 126 may include one or more algorithms that analyze various forms of data, including but not limited to, data received in response to the electronic questionnaires. In some embodiments, the algorithms may calculate one or more performance scores that are indicative of the institution's performance based on data received from questionnaires and/or databases. In one approach, the algorithms may assign weight to questionnaire responses and may calculate the performance score based, at least in part, on the assigned weight. In another approach, the algorithms may compare institutional data with national and/or regional data. In some embodiments, the algorithms may compare data associated with a particular police agency to national and/or regional statistics. For example, the algorithms may calculate national and/or regional averages for crime data (e.g., a number of fatal shootings by police, a number of law enforcement officers killed, a number of violent crime incidents, a number of property crime incidents, etc.) or policing performance metric data (e.g., a number of assaults against officers, a number of citizen complaints, a number of police misconduct lawsuits, a number of use of force incidents, a number of service calls, etc.). The algorithms may also compare national and/or regional averages to the police agency's crime data or policing performance metric data.

It is also contemplated that the analytics engine 126 may include one or more machine learning algorithms that may analyze questionnaire response to determine performance scores associated with an institution, such as a police agency. In the manner, the analytics engine 126 may leverage historical questionnaire response and performance scores to train the machine learning algorithms and better predict performance scores based on questionnaire responses. The analytics engine 126 may also include one or more machine learning algorithms that analyze performance scores to determine correlations between performance scores and any data in the databases 104. The algorithms may leverage historical performance scores and data from agency databases 204 (e.g., incident data, employee data, policy data, demographic data for the agency) to train the machine learning algorithms and determine correlations between performance scores and agency attributes. In some approaches, these correlations can then be used to ascertain effective measures to recommend to agencies to thereby improve effectiveness or performance scores.

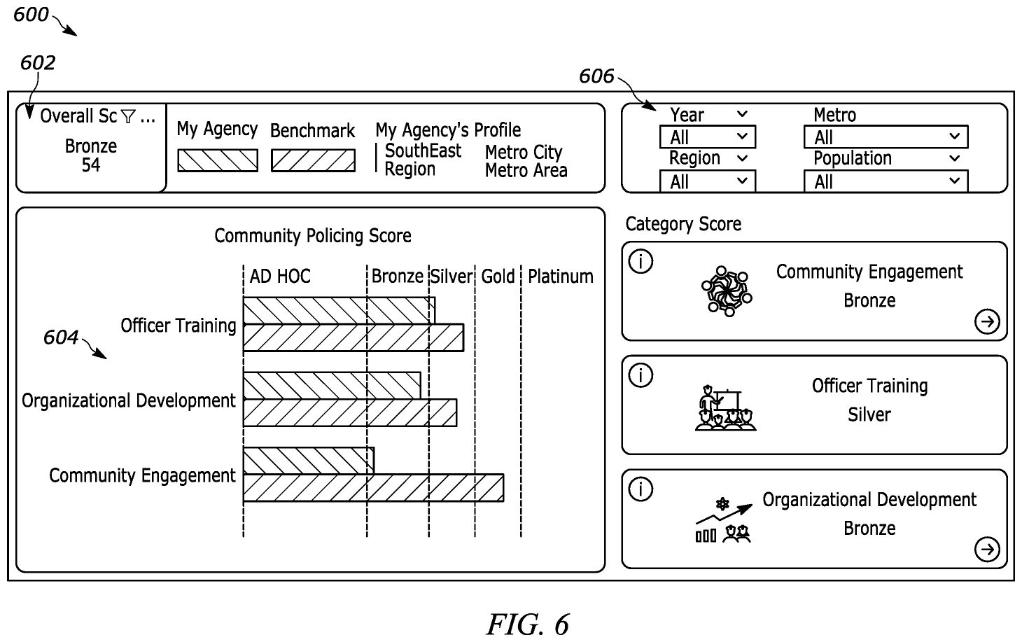

The visualization engine 128 provides for the visualization of the scores and other performance data or metrics generated by the analytics engine 126. The visualization engine 128 may provide such visualizations on the user interface 118 of the electronic user device 120. The visualization engine 128 is capable of generating and displaying institutional performance scores. In some embodiments, when the system 100 is used to evaluate a police agency, the visualization engine 128 may also display crime data and other policing metric data trends, for example, comparing national and/or regional data to data for a particular police agency. Data for such trends may be received from the databases 104, the data collection tool 124, and/or the analytics engine 126. Example visualization graphics generated by the visualization engine 128 are shown in FIGS. 6-8.

The corrective action engine 130 may include one or more algorithms that analyze various forms of data, including but not limited to, crime or incident data, performance metric data, and performance scores generated by the analytics engine 126. In some embodiments, the algorithms may assign one or more corrective actions to an institution based on the crime or incident data, performance metric data, and/or performance scores.

It is also contemplated that the corrective action engine 130 include one or more machine learning algorithms that may analyze performance scores to identify corrective actions to recommend to an agency. The machine learning algorithms may be trained to identify corrective actions based on the performance scores associated with an agency. In the manner, the analytics engine 126 may leverage historical performance scores and historical corrective actions to better predict corrective actions that will improve performance scores.

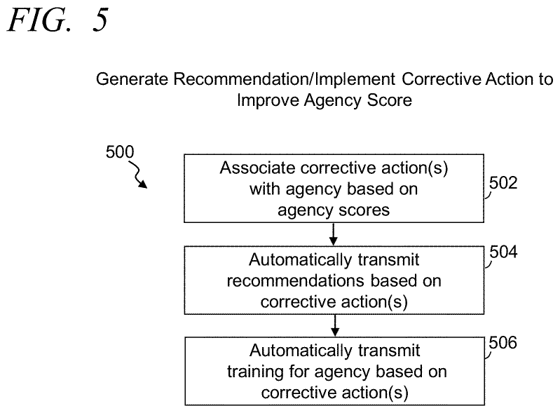

In addition, as discussed with respect to FIG. 5 below, the system 100, for example via the corrective action engine 130, also may transmit training recommendations to the user. By one approach, the training recommendations are sent to the principal user. In another configuration, the training recommendations also may be sent directly to secondary users, which may not lead the associated institution, but are individuals connected therewith. For example, if the corrective action engine 130 identified one or more officer training courses would be of value for a segment of individuals associated with an institution, the corrective action engine 130 may send links or modules from a training portal to a variety of individuals associated with the institution. In this manner, the system 100, such as via the analytics engine 126, can quickly respond to trends identified in the data gathered via the data collection tool 124, the database(s) 104 or the unstructured data input 106.

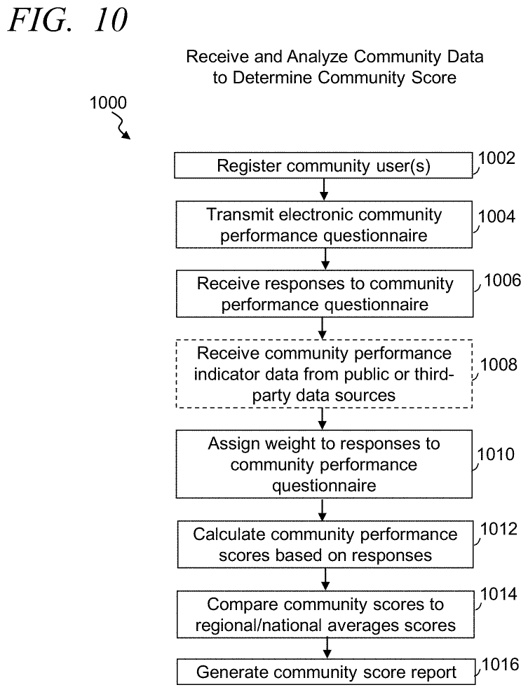

The community evaluation module 130 may be in communication with the databases 104, unstructured data input 106, and the electronic devices 120. It is also contemplated that the community evaluation module may be part of or in communication with the agency evaluation module 122. In some embodiments, the community evaluation module 130, may be used to implement the methods illustrated with reference to FIGS. 10-12.

The data collection tool 134 may be configured to collect information or data relevant to the assessment of a community. In some approaches, the data collection tool 134 may be configured to transmit one or more electronic surveys or questionnaires to an electronic device 120 associated with a user. The user may be, for example, any past or present member of the community. The questionnaires may include one or more questions, prompts, or requests for information for the user relevant to the assessment of a community, in particular, to the community's public safety, physical health, mental health, economic opportunities, and educational opportunities. The questionnaires may also include one or more questions, prompts, or requests for information for the user related to user demographics. In response to transmitting the electronic surveys or questionnaires, the data collection tool 134 may receive information or data relevant to the assessment of the community. For example, the user may input information related to the queries, prompts, or requests for information via the user interface 118 associated with the electronic user device 120. The data collection tool 134 may also be configured to query one or more databases 104 in order to gather data such as crime data or other data indicative of community safety and wellbeing.

In some embodiments, the data collection tool 134 may also facilitate the creation of a confidential account for a user associated with the community to ensure data collection remains confidential. As part of the account creation, the data collection tool 134 may receive a user identifier associated with the particular use. For example, the user may enter a user identifier via an electronic device 120. In another example, the user identifier may be automatically read from some piece of media, for instance smartcard or keycard. The user identifier may, for example, be encoded in a magnetic stripe, machine-readable symbol, or wireless transponder (e.g., RFID transponder) of the smartcard or keycard. In this manner, the data collection tool 134 may associate collected data with the user identifier and may limit access to collected data to the user associated with the user identifier.

The analytics engine 136 analyzes data that is relevant to the performance of a community in order to evaluate community safety and wellbeing and assign a community safety and wellbeing score to the community. In some approaches, the analytics engine 136 receives data, either directly or indirectly, from the data collection tool 134. In other approaches, the analytics engine 136 may also receive data directly from the databases 104, unstructured data inputs 106, or electronic devices 120. After receiving relevant data, the analytics engine 136 weighs the data to assign a community safety and wellbeing score to the community. In some embodiments, the analytics engine 136 may receive data from a plurality of members of a community, for example in the form of questionnaire responses, in order to calculate a community safety and wellbeing score. In one example, the community safety and wellbeing scores may be assigned for various performance areas such as public safety, health, and access to resources.

The analytics engine 136 may include one or more algorithms that analyze various forms of data, including but not limited to, data received in response to the electronic questionnaires. In some embodiments, the algorithms may calculate one or more community safety and wellbeing scores that are indicative of the community's performance based on data received from questionnaires and/or databases. In one approach, the algorithms may assign weight to questionnaire responses and may calculate the community safety and wellbeing score based, at least in part, on the assigned weight. In another approach, the algorithms may compare agency data with national and/or regional data. For example, the algorithms may calculate national and/or regional averages for crime data (e.g., a number of fatal shootings by police, a number of law enforcement officers killed, a number of violent crime incidents, a number of property crime incidents, etc.) or community safety and wellbeing indicator data (e.g., life expectancy, mental illness rates, median income, etc.). The algorithms may also compare national and/or regional averages to agency crime data or community safety and wellbeing indicator data.

It is also contemplated that the analytics engine 136 may include one or more machine learning algorithms that analyze questionnaire response to determine community safety and wellbeing scores associated with the community. In this manner, the analytics engine 136 may leverage historical questionnaire response and community safety and wellbeing scores to train the machine learning algorithms and to better predict community safety and wellbeing scores based on questionnaire response. The analytics engine 136 may also include one or more machine learning algorithms that analyze community safety and wellbeing scores to determine correlations between scores and any data in the databases 104. The algorithms may leverage historical community safety and wellbeing scores and data from agency databases 204 (e.g., incident data, employee data, policy data, demographic data for the agency) to train the machine learning algorithms and determine correlations between community safety and wellbeing scores and agency attributes.

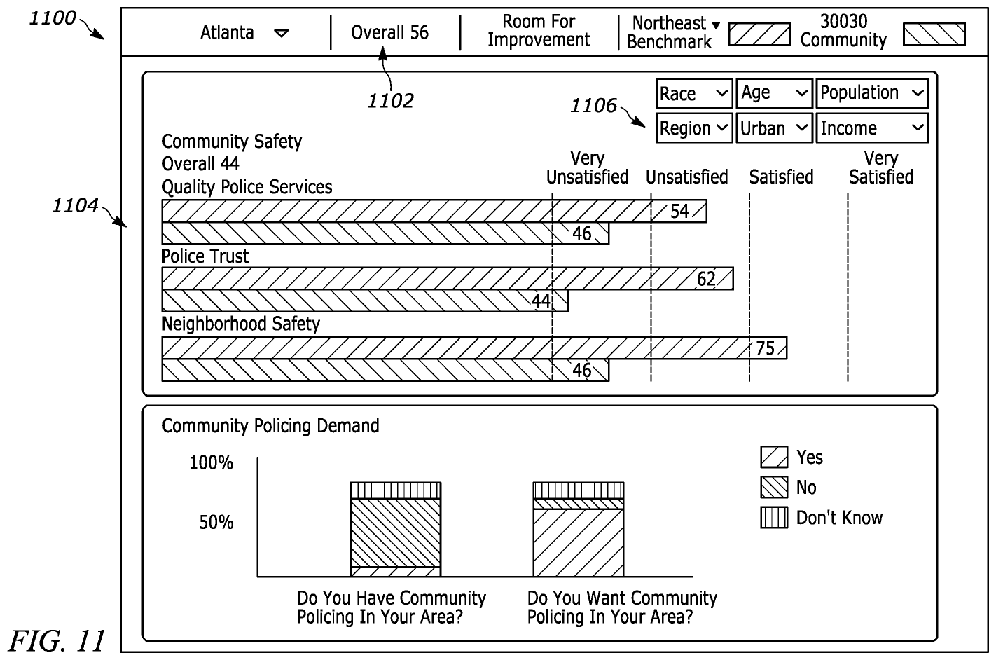

The visualization engine 138 provides for the visualization of the community scores and other community safety and wellbeing data or metrics generated by the analytics engine 136. The visualization engine 138 may provide such visualizations on the user interface 118 of the electronic user device 120. The visualization engine 138 is capable of generating and displaying community safety and wellbeing scores. The visualization engine 138 is also capable of community safety and wellbeing indicator data trends, for example, comparing national and/or regional data to data for a particular community. Data for such trends may be received from the databases 104, the data collection tool 134, and/or the analytics engine 136. Example visualization graphics generated by the visualization engine 138 are shown in FIGS. 11-13.

FIG. 2A illustrates an exemplary database structure 200A that may be employed with the agency evaluation module 122. The database structure 200A includes one or more public databases 202, agency or institution databases 204, and survey databases 206. It is contemplated that the data used in the database structure 200A may be any data relevant to the assessment of policing performance. The public databases 202 may include incident data 208, crime data 212, leadership or employee data 214, gun violence data 215, legal data 216, and map data 217. Incident data 208 may be, for example, data that relating to incidents, events, etc. associated with an institution. When the institution being evaluated is a police agency, incident data 208 may include data on arrests, incidents reported, or other events associated with the agency. Leadership or employee data 214 may be data relating to numbers of employees or details about particular employees or leaders associated with an institution. When the institution being evaluated is a police agency, the leadership or employee data 214 may include data on law enforcement officers feloniously killed, accidently killed, or assaulted in the line of duty. Crime data 212 may be, for example, data relating to crimes or complaints associated with an institution. When the institution being evaluated is a police agency, the crime data 212 may include violent crime, domestic crime, property crime, or hate crime rates or volumes. Gun violence data 215 may include number of gun violence deaths, suicides, gun injuries, mass shootings, officer involved incidents, murders, homicides, and unintentional injuries. Legal data 216 may include data relating to legal proceedings, documents, or orders associated with an institution. When the institution being evaluated is a police agency, the legal data 216 may include data relating to consent decrees. Such public databases 202 may be data repositories provided and/or maintained, for example, by national agencies like the Federal Bureau of Investigations (FBI) or regional or local agencies such as local police departments or precincts. Examples of public databases include the Crime Data Explorer, Uniform Crime Reporting (UCR), Washington Post, National Incident-Based Reporting System (NIBRS), and Consent Decrees databases. Such public data may also be sourced or aggregated by third parties. Map data 217 may include the location of incidents, events, or crimes; geographic boundaries or regions associated with an institution; and the location of facilities such as hospitals, offices, stores, parks public transportation, museums, schools, libraries, etc.

The database structure 200A may also include one or more agency databases 204. The agency databases 204 may include crime data, employee data, and police data associated with a particular police agency. The agency databases 204 may be data repositories provided and/or maintained, for example, by a national, regional, or local institutions, such as a police department or precinct. The agency databases 204 may include agency incident data 218, agency employee data 220, agency policy data 222, and agency demographic data 223. The agency incident data 218 may include reports or statistical data related to incidents associated with the agency. The agency incident data 218 may include any data related to incidents that is tracked by the institution or agency. The agency employee data 220 may track information on the agency's employees, such as disciplinary actions, injuries, employee performance, salary, demographic information, training, educational background, etc. Agency policy data 222 may include data on policies in place at the agency. Agency demographic data 223 may include data on the age, gender, race, etc. of various officers, managers, or other employees associated with the agency.

The database structure 200A may also include one or more survey databases 206. The survey databases 206 may include community engagement data 224, training data 226, and organizational development data 228. The community engagement data 224 may include any data that is indicative of an institution's community engagement or ability to work collaboratively and through individuals associated with the community. When the institution being evaluated is a police agency, the community engagement data 224 may relate to community input, policing practices, policing priorities, and overall policing philosophy. The training data 226 may include any data related to an institution's training procedures or content. For example, training data 226 may include types of training programs offered, types and number of employees trained, or frequency of training. The organizational development data 228 may include any data that is indicative of the institution's organizational development. The organizational development data 228 may include data related to leadership, processes, policies, management, initiatives, metrices, communication, accountability, etc. at the institution. When the institution being evaluated is a police agency, organizational data 228 may relate to officer promotion, officer discipline, policing practices, internal agency practices and communication, officer safety and wellbeing, etc. In some embodiments, the survey databases may be populated using the system 100, for example using questionnaires transmitted by the data collection tool 124.

FIG. 2B illustrates an exemplary database structure 200B that may be employed with the community evaluation module 130. It is contemplated, the data used in the database structure 200B may be any data relevant to the assessment of community safety and wellbeing. The database structure 200B may include one or more public databases 230 and survey databases 232. Such public databases 202 may be data repositories provided and/or maintained, for example, by national, regional, or local agencies or third parties. The public databases 230 may include life expectancy data 244, mental illness data 246, incident data 250, income data 252, and map data 254 associated with one or more communities or locations. Map data 254 may include the location of incidents, events, or crimes; geographic boundaries or regions associated with an institution; and the location of facilities such as hospitals, offices, stores, parks, public transportation, schools, museums, libraries, etc.

It is contemplated that the public database 230 may include any safety and wellbeing data that is associated with a community. Examples of such safety and wellbeing data include, but are not limited to data related to length of life, poor or fair heath rates, air pollution, vaccination rates, unemployment rates, high school completion rates, college completion rates, percentage of children in poverty, percentage of single-parent households, injury, deaths, drinking water violations, percentage of individuals uninsured, ratio of dentists, ratio of primary care physicians, number of preventable hospital stays, access to exercise opportunities, food environment index, smoking rates, obesity rates, disease rates, economic factors, etc.

The survey databases 232 may include demographic data 234, public safety data 236, physical health data 238, mental health data 240, and economic opportunity and education data 242. In some embodiments, the survey databases may be populated using the system 100, for example using questionnaires transmitted by the data collection tool 124.

It should be understood that the data collected and analyzed by the system 100 is not limited to the data shown in FIGS. 2A and 2B. Further, the relevant data may be sourced from any or housed in any suitable database structure and all databases need not be housed on a single server.

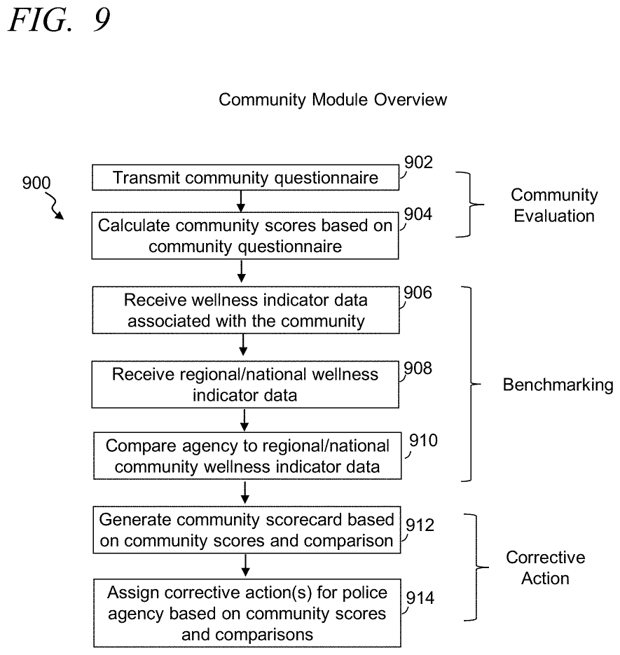

The performance evaluation system 100 illustrated in FIG. 1 may be used to execute various methods for evaluating the performance of any institution, organization, or agency and/or the community it serves. In some embodiments, the system 100 is employed to evaluate the performance of a police agency. FIGS. 3-5 illustrate several exemplary methods of operating the performance evaluation system 100 to evaluate a police agency or other organization. Similarly, FIGS. 9-10 illustrate exemplary methods of operating the performance evaluation system to evaluate a community that is served by or otherwise associated with the police agency.

Turning to FIG. 3, an exemplary method 300 of operating the performance evaluation system 100 is illustrated. In some embodiments, one or more steps of the method 300 may be performed using the agency evaluation module 122. The method 300 is an overview of how the system 100 may be employed to evaluate a police agency, benchmark agency performance data against national and/or regional data, and automatically generate corrective actions for the police agency.

To evaluate the police agency, the system may transmit 302 an electronic agency questionnaire or survey to one or more users associated with the police agency. As discussed above, the agency questionnaire may include one or more questions, prompts, and request for information indicative of community policing performance. In some embodiments, the agency questionnaire may be probative of the police agency's officer training, organizational development, and community engagement. Further, the system may receive information or data in response to transmitting the agency questionnaire. The system then calculates 304 a performance score based, at least in part, on the responses to the agency questionnaire. In some embodiments, the analytics engine 126 calculates the performance score for the police agency, for example, by assigning weight to responses received in response to the agency questionnaire. In some approaches, the responses may be weighted to generate a community policing score that is indicative of the police agency's ability to engage in community policing.

In addition, the system may benchmark agency crime and policing metric data against regional and/or national data. For benchmarking, the system receives 306 agency crime data. The system also receives 308 regional and/or national crime data. In some approaches, the agency crime data and the regional and/or national crime data may include data relating to one or more of fatal shootings by police, law enforcement officers feloniously killed, property crime rates, violent crime rates. In some embodiments, the system 100 may receive agency crime data and regional and/or national crime data from one or more databases 104. For example, the crime data may be sourced from one or more of the Federal Bureau of Investigation (FBI) Uniform Crime Report (UCR), the FBI National Incident-Based Reporting System (NIBRS), and the Washington Post databases. The system then compares 310 the agency crime data to the regional and/or national crime data. In this manner, the system gauges how well the agency performs with respect to crime relative to regional and/or national standards. The system may receive 306, 308 crime data periodically or in real-time.

For benchmarking, the system receives 312 agency policing metric data. The system also receives 314 regional and/or national policing metric data. In some approaches, the agency policing metric data and the regional and/or national policing metric data may include data relating to one or more of assaults against police officers, service calls, citizen complaints, police misconduct lawsuits, and use of force incidents. In some embodiments, the system 100 may receive agency policing metric data and regional and/or national policing metric data from one or more databases 104. For example, the crime data may be sourced from one or more of the FBI UCR, the FBI NIBRS, and the Washington Post databases, among others. The system then compares 316 the agency policing metric data to the regional and/or national policing metric data. In this manner, the system gauges how well the agency performs with respect to various policing metrics relative to regional and/or national standards. The system may receive 312, 314 policing metric data periodically or in real-time.

In some approaches, the regional and/or national crime data and policing metric may be categorized by one or more of: region type (e.g., urban, rural, suburban); population density; region location (e.g., Southwest, Southeast, Northwest, Northeast); and year. In this manner, the system may benchmark agency performance against these various standards (e.g., region type, population density, region location, year).

The system may then generate 318 one or more electronic scorecards for the police agency based on one or more of the police agency's performance scores and the comparison of agency crime and policing metric data to regional and/or national standards. The electronic scorecards may be dynamic and may automatically update, for example, as performance scores are calculated and/or updated. Exemplary electronic scorecards are illustrated in FIGS. 6-8. Further, the system may automatically assign 320 one or more corrective actions to the police agency. In some approaches, the system assigns corrective actions, such as recommendations or specific trainings, based on one or more of the police agency's performance scores and the comparison of agency crime and policing metric data to regional and/or national standards.

In some embodiments, the method may also include receiving input (e.g., in the form of questionnaire responses) indicating whether the police agency has implemented one or more corrective actions. In response, the system may automatically update or recalculate the performance score that is generated at step 304. In this manner, the performance score may be update in real time as the as the police agency implements corrective actions. Ongoing training may automatically increase the police agency's performance score. For example, the agency's officer training performance score may automatically update when the agency implements a training course or when a certain percentage of officers complete a particular type of training.

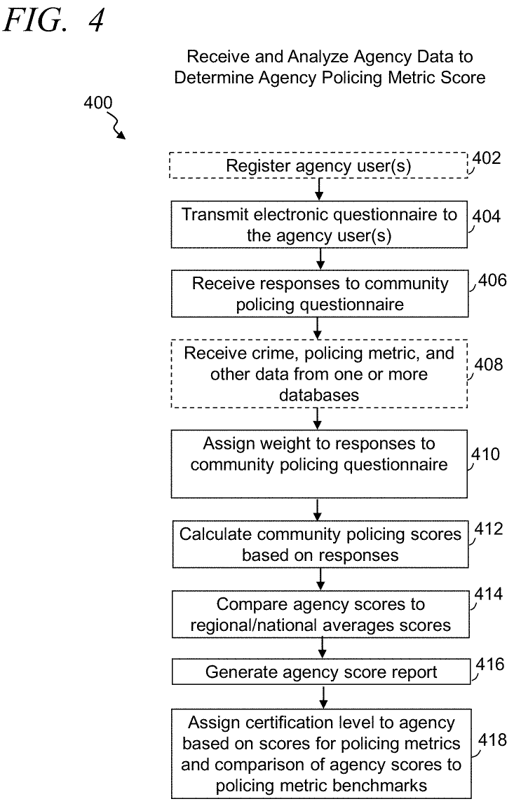

Further, one or more portions of the process 300 may be conducted in a regular manner, such as quarterly or yearly, to provide updated scores to identify trends in the agency's performance. Indeed, some portions of process 300 may be conducted relatively frequently such that corrective actions 320 may be recommended in real-time such as in response to incidents that are reflected in updated metric data. Turning to FIG. 4, another exemplary method 400 of operating the policing performance evaluation system 100 is illustrated. In some embodiments, one or more steps of the method 400 may be performed by the agency evaluation module 122. The method 400 may be used, for example, to acquire and analyze data associated with a police agency in order to evaluate the police agency's ability to engage in community policing.

In the method 400, the system may first register 402 a user associated with the police agency. The registration 402 may involve creating a confidential account associated with the police agency and/or the user. The system then transmits 404 an electronic questionnaire to the agency user. In some approaches, the system transmits 404 the electronic questionnaire to the agency user via the confidential account. As discussed above, the electronic questionnaire may include questions, prompts, or requests for information related to one or more of the policing agency's officer training, organizational development, and community engagement. In response to the electronic questionnaire, the system receives 406 responses in the form of data or information.

In some embodiments, the system may also receive 408 crime, policing metric, and other data from one or more databases. For example, the crime data, policing metric, or other data may be sourced from one or more of the FBI UCR, the FBI NIBRS, and the Washington Post databases, among others. In some approaches, such data may be received from the databases illustrated in FIG. 2A. In this manner, the evaluation of the police agency may be based on crime, policing metric, and other data, in addition to data or information received in response to the electronic questionnaires.

It is contemplated that, as part of method 400, any of the data received by the system, whether from electronic questionnaires or databases, may undergo a validation step. The validation step may involve validating or verifying data and information that is input into the system and used for agency evaluation purposes. In some examples, validation may be conducted by a third party such as a research entity. The validation step may be automatic, for example, a validation workflow may be automatically initiated as part of the data collection process (e.g., steps 402-408 of method 400).

After receiving data related to the police agency, the system then assigns 410 weight to the data. For example, the system may assign weight (e.g., in the form of number values) to questionnaire responses, crime data, policing metric data, and other data which may be used to calculate one or more scores for the police agency. The system also calculates 412 one or more performance scores based on the questionnaire response. In some approaches, the system may also calculate 412 the performance score based on other data or information. The performance score may be a dynamic score, that is adjusted based on real-time data. For example, real-time gun violence data or crime data, such as violent crime rates, property crime rates, or domestic crime rates may automatically update the police agency's performance score. In some embodiments, the system also compares 414 the police agency's performance scores to national and/or average performance scores. For example, the system may be configured to aggregate data from a plurality of police agencies to calculate regional and/or national averages by which a particular police agency's performance may be measured. In this manner, the method 400 compares agencies against each other in an aggregated manner.

After calculating scores, the system may generate 416 one or more electronic score reports for the police agency. Exemplary electronic score reports or scorecards are illustrated in FIGS. 6-8. Further, the system may assign 418 a certification level to the police agency based on the calculated scores. In some approaches, the police agency's certification level may also be based on a comparison of the police agency's scores with regional and/or national average scores. In some embodiments, the certification level may be one or more of ad hoc, bronze, silver, gold, and platinum.

In some embodiments, the method 400 may also include automatically associating performance scores with various agency attributes, such as demographic data of the officers or employees, trainings conducted by the agency, agency policies, agency initiatives, etc. For example, the system may receive data from agency databases 204 that include data or information on the police agency being evaluated. In this manner, the system may automatically generate correlations between performance scores and agency attributes to identify indicators of agency success. For example, certain demographic data may correlate with higher performance scores in the area of community engagement.

In addition, the method 400 of evaluating an agency may also compare agencies performance scores based on the demographic features of the community within which it sits and/or how analogous or dissimilar the agency is as compared to the community it serves. For example, the system may receive demographic data on a community associated with the police agency. Such data may be aggregated for all police agencies that have been evaluated by the system, for example, using method 400. Further, community demographic features may be represented on the electronic scorecards. The electronic scorecards may also compare the agency's performance to other agencies based on demographic features associated with the agencies.

Turning to FIG. 5, another exemplary method 500 of operating the policing performance evaluation system 100 is illustrated. In some embodiments, one or more steps of the method 500 may be performed by the agency evaluation module 122. The method 500 may be used, for example, to automatically assign one or more corrective actions based on an evaluation the police agency's ability to engage in community policing.

In the method 500, the system automatically associates 502 one or more corrective actions with the police agency based on the police agency's scores, including for example, performance scores. In some approaches, the corrective actions may be associated with particular performance scores in a database. In this manner, the system may automatically associate corrective actions with a particular performance score, score range, or certification level. For example, when a police agency has a low score for officer wellness, the system may automatically recommend that the police agency engage in mental health check-ins or other wellness related interventions for officers. Indeed, as suggested above, the system 100 may automatically transmit training modules to various users or officers associated with an institution to provide them the training tools or modules upon identification of officers' needs. In other approaches, the system may automatically associate corrective actions with a police agency based on responses related to an electronic questionnaire. For example, if an agency user submits a response indicating that the agency does not conduct a particular type of training, the system may automatically generate a recommendation that the agency implement that type of training.

It is also contemplated that, to generate corrective actions, the system may extract one more corrective actions from consent decrees. The system may also evaluate a performance score for the particular agency subject to the consent decree. In this manner, the system may automatically associate consent decree corrective actions performance scores and automatically assign consent decree corrective actions to the police agency.

The system may also automatically transmit 504 one or more electronic recommendations, messages, alerts, reports, etc. to the police agency based on the police agency's performance score. In some approaches, the electronic recommendations may be transmitted to an account or user interface associated with the police agency.

In some embodiments, the system may automatically transmit 506 one or more electronic training programs to the police agency based on the police agency's assigned corrective action and/or the performance score. In some approaches, the electronic training programs may be transmitted to an account associated with the police agency.

In some approaches, the trainings transmitted 506 to the police agency may be trainings required for particular certification purposes. However, in other approaches, the trainings transmitted 506 to the police agency may be other trainings not required for certification purposes; rather, the trainings may have been those demonstrated to provide improved organizational outcomes, for example, in areas such as anti-bias, duty to intervene, leadership, trauma-informed approaches, mindfulness, etc. It is also contemplated that the system 100 may be used to identify particular trainings that improve organizational outcomes. For example, algorithms in the corrective action engine 130 may automatically identify correlations between trainings conducted by an institution and performance scores. In this manner, the system 100 may identify and recommend particular trainings that correlate with improved organizational outcomes.

FIGS. 6-8 illustrate exemplary user interfaces that may be generated by the agency evaluation module 122. In FIG. 6, the user interface 600 includes an exemplary electronic scorecard generated by the system, illustrating performance scores related to community policing. The user interface 600, includes the particular overall community policing score 602 for the police agency. The user interface 600 also includes a score breakdown 604, displaying scores for specific performance categories, including officer training, organizational development, and community engagement. The user interface 600 also displays benchmarking filters 606. The benchmarking filters 606 include year, region, population, and metro area type. In this manner, a user associated with the police agency may select a particular benchmarking standard by which the police agency is measured. In some embodiments, the system may calculate an average performance scores for all agencies, such averages may also be on a regional or national basis. The scorecard may include average performance scores so that an agency may compare its performance scores to national or regional averages. In this manner, the scorecards may compare agencies in an aggregated manner.

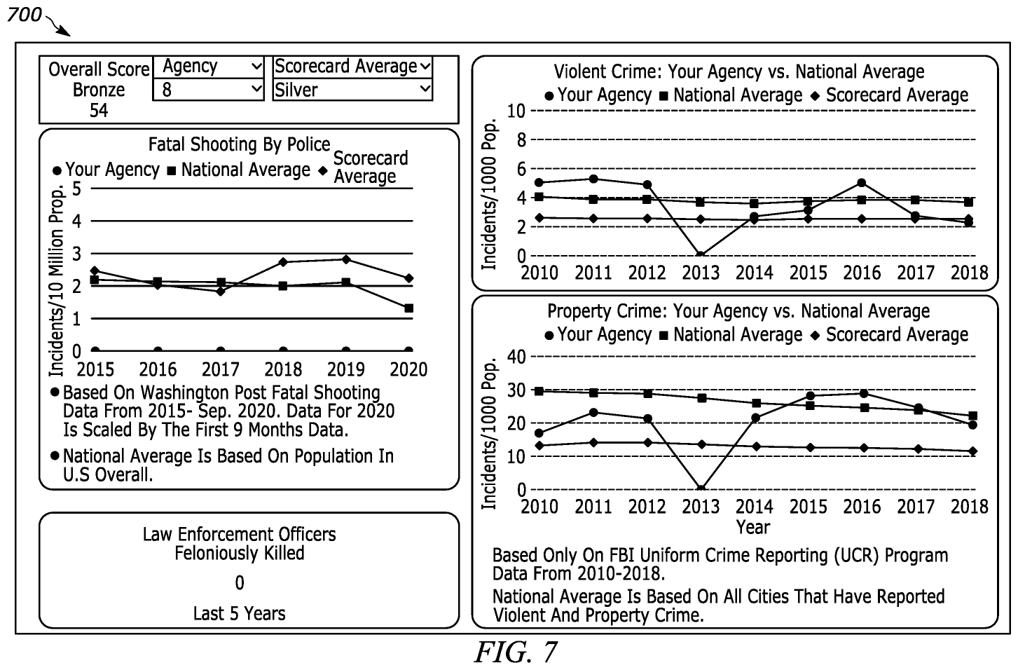

In FIG. 7, the user interface 700 displays graphs and other visuals depicting various forms of crime data associated with the police agency. The crime data displayed on user interface 700 includes fatal shootings by police, violent crime rates, property crime rates, and law enforcement officers feloniously killed. However, it is contemplated that other forms of crime data may be displayed. The graphs also depict national averages for the various forms of crime data. In this manner, the user interface 700 compares the police agency to national averages.

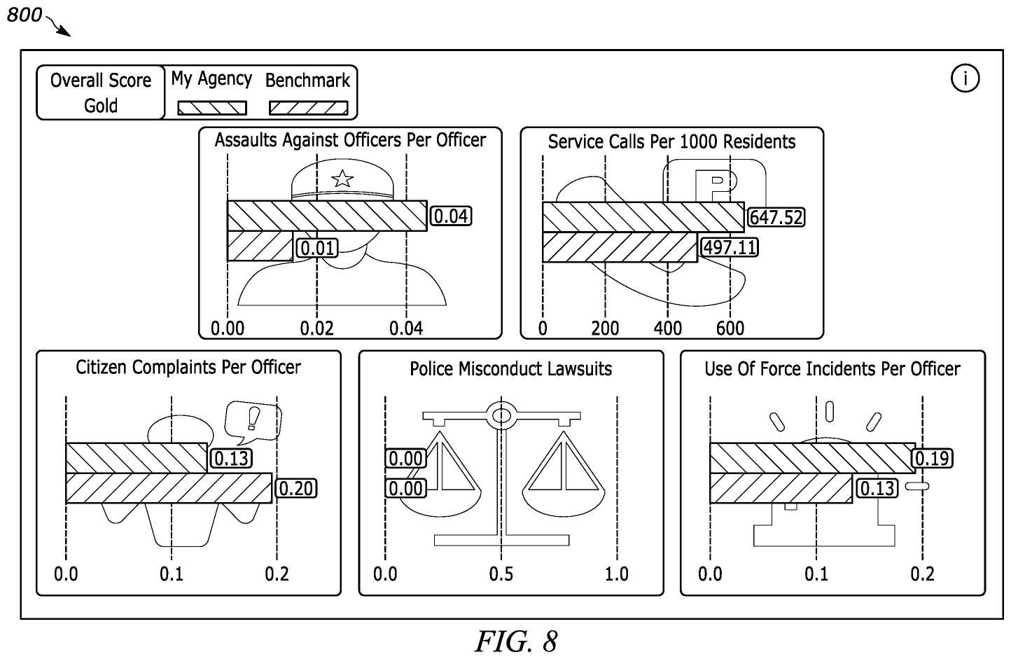

In FIG. 8, the user interface 800 displays graphs depicting various forms of policing metrics associated with the police agency. The policing metrics displayed on the user interface 800 include assaults against officers, number of citizen complaints, police misconduct lawsuits, number of service calls, and number of use of force incidents. However, it is contemplated that other policing metrics may be displayed. The graphs also depict the policing metrics for a particular benchmark. As illustrated in FIG. 6, the benchmarking standard to which the police agency is compared may be selected via one or more filters.

Turing to FIG. 9, an exemplary method 900 of operating the policing performance evaluation system 100 is illustrated. In some embodiments, one or more steps of the method 900 may be performed using the community evaluation module 132. The method 900 is an overview of how the system 100 may be employed to evaluate a community, benchmark community safety and wellbeing data against national and/or regional data, and automatically generate corrective actions for the community.

To evaluate the police agency, the system may transmit 902 a community questionnaire to one or more users associated with the police agency. As discussed above, the agency questionnaire may include one or more questions, prompts, and request for information indicative of community safety and wellbeing. In some embodiments, the agency questionnaire may be probative of the community's public safety, physical health, mental health, economic opportunities, and educational opportunities. Further, the system may receive information or data in response to transmitting the community questionnaire. The system then calculates 904 a community score based, at least in part, on the community questionnaire. In some embodiments, the analytics engine 136 calculates the community score, for example, by assigning weight to responses received in response to the community questionnaire.

In addition, the system may benchmark the community's safety and wellbeing indicator data against regional and/or national safety and wellbeing indicator data. For benchmarking, the system receives 906 safety and wellbeing indicator data associated with the community. The system also receives regional and/or national safety and wellbeing indicator data. In some approaches, the agency's community safety and wellbeing indicator data and the regional and/or national safety and wellbeing indicator data may include data relating to one or more of life expectancy, income, mental illness, and violent crime rates. In some embodiments, the system 100 may receive safety and wellbeing indicator data associated with the community and regional and/or national safety and wellbeing indicator data from one or more databases 104. The system then compares 910 the safety and wellbeing indicator data associated with the community to the regional and/or national safety and wellbeing indicator data. In this manner, the system gauges how well the community performs with respect to safety and wellbeing indicators relative to regional and/or national standards.

In some approaches, the regional and/or national safety and wellbeing indicator data may be categorized by one or more of: region type (e.g., urban, rural, suburban); population density; region location (e.g., Southwest, Southeast, Northwest, Northeast); and year. In this manner, the system may benchmark community safety and wellbeing against these various standards (e.g., region type, population density, region location, year).

The system may then generate 912 one or more electronic scorecards for the community based on one or more of the community's scores and the comparison of the community's safety and wellbeing indicator data to regional and/or national standards. The electronic scorecards may be dynamic, for example, may automatically update as scores are calculated and/or updated. Exemplary electronic scorecards are illustrated in FIGS. 11-13. Further, the system may automatically assign 914 one or more corrective actions to a police agency associated with the community. In some approaches, the system assigns corrective actions based on one or more of the community's scores and the comparison of community's safety and wellbeing indicator data to regional and/or national standards.

In some embodiments, the method 900 may also include updating the performance score for a police agency associated with the community based on the community scores and/or on the community's safety and wellbeing indicator data. In this manner, the performance score for a police agency may be updated in real time based on the evaluation of the community it serves. Further, the police agency scorecard may also automatically and dynamically update based on the updated performance scores.

In some embodiments, training courses or recommendations may also be automatically generated for a police agency associated with the community based on the community scores and/or on based on the community's safety and wellbeing indicator data. Training courses or recommendations may also be generated based on particular responses to the community questionnaire. For example, the community questionnaire responses may indicate that fear of police is a top concern for the community; in response, the system may automatically generate a training recommendation geared at improving fear of police.

Turning to FIG. 10, an exemplary method 1000 of operating the policing performance evaluation system 100 is illustrated. In some embodiments, one or more steps of the method 1000 may be performed using the community evaluation module 132. The method 1000 may be used, for example, to acquire and analyze data associated with a community in order to evaluate community safety and wellbeing.

In the method 1000, the system may first register 1002 a user associated with the community. The registration 1002 may involve creating a confidential account associated with the user. The system then transmits 1004 an electronic questionnaire to the community user. In some approaches, the system transmits 1004 the electronic questionnaire to the community user via the confidential account. As discussed above, the electronic questionnaire may include questions, prompts, or requests for information related to one or more of the community's public safety, physical health, mental health, economic opportunities, and educational opportunities. In response to the electronic questionnaire, the system receives 1006 responses in the form of data or information. In some approaches, the electronic questionnaire may be sent to any person associated with the community. In some embodiments, the electronic questionnaire may be sent to any individual associated with a particular zip code.

It is also contemplated that a questionnaire or survey may be conducted via the telephone and responses entered into a database. For example, a phone system may automatically call an individual and prompt the individual to enter responses either verbally or through a keypad of the telephone. In some embodiments, the system may automatically transmit an electronic questionnaire (e.g., via a hyperlink) to a community member, either via an electronic device or a telephone, after an encounter with a police agency. In other embodiments, the system may transmit questionnaires to community members on a periodic basis.

In some embodiments, the system may also receive 1008 safety and wellbeing indicator and other data from one or more databases. The safety and wellbeing indicator data may include data related to life expectancies, mental health, demographics, income, and/or crime. In some approaches, such data may be received from the databases illustrated in FIG. 2B. In this manner, the evaluation of the community may be based on safety and wellbeing indicator and other data, in addition to data or information received in response to the electronic questionnaires.

After receiving data related to the community, the system then assigns 1010 weight to the data. For example, the system may assign weight (e.g., in the form of number values) to questionnaire responses, safety and wellbeing indicator data, and other data which may be used to calculate one or more scores for the community. The system also calculates 1012 one or more community scores based on the questionnaire response. In some approaches, the system may also calculate 1012 the community score based on other data or information.

In some embodiments, the community scores may be dynamic and automatically update as additional data is received. In some approaches, the community scores may be automatically updated as individuals from the community complete electronic questionnaires. In other approaches, the community scores may be automatically updated as additional safety and wellbeing indicator data is received. For example, as median income increases, violent crime rate drops, life expectancy increases, or mental illness drops, the community score may automatically increase. In some embodiments, the system also compares 1014 the community's community scores to national and/or average community scores. For example, the system may be configured to aggregate data from a plurality of communities to calculate regional and/or national averages by which a particular community's safety and wellbeing may be measured.

After calculating scores, the system may generate 1016 one or more electronic score reports for the community. In some embodiments, the electronic scorecard may automatically and dynamically update based on updates to the community scores and/or based on updates to community safety and wellbeing data. Exemplary electronic score reports are illustrated in FIGS. 11-13. Further, the system may assign a safety and wellbeing level to the community based on the calculated scores. In some approaches, the community's safety and wellbeing level may also be based on a comparison of the community's scores with regional and/or national average scores. In some embodiments, the safety and wellbeing level may be one or more of very unsatisfied, unsatisfied, satisfied, and very satisfied.

In some embodiments, the method 1000 may also include automatically associating community scores with various attributes of a police agency (or other organization) associated with the community. Such attributes of the police agency may include demographic data of the officers or employees, trainings conducted by the agency, agency policies, agency initiatives, etc. For example, the system may receive data from agency databases 204 that house data or information on the police agency being evaluated. In this manner, the system may automatically generate correlations between community scores and agency attributes to identify agency attributes that correspond to higher community scores. For example, certain demographic data of an agency or particular trainings conducted by an agency may correspond with higher community scores. In this manner, the community evaluation may be tied into agency attributes.

FIGS. 11-13 illustrate exemplary user interfaces that may be generated by the community evaluation module 132. In FIG. 11, the user interface 1100 includes an exemplary electronic scorecard generated by the system. The user interface 1100, includes the particular overall community score 1102 for the community. The user interface 1100 also includes a score breakdown 1104, displaying scores for specific safety and wellbeing categories, including the quality of police services, police trust, and neighborhood safety. The user interface 1100 also displays benchmarking filters 1106. The benchmarking filters 106 include year, region, population, and metro area type. In this manner, a user associated with the community may select a particular benchmarking standard by which the community is measured.

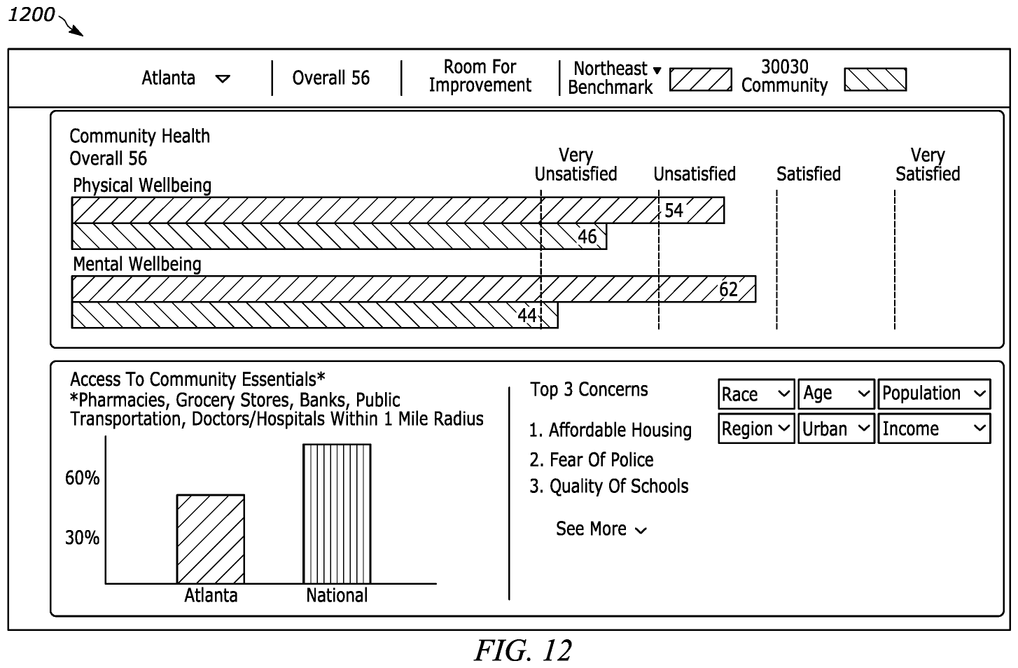

In FIG. 12, the user interface 1200 displays graphs and other visuals depicting another community scorecard associated with the community. The community score breakdown displayed on user interface 1200 includes scores for specific safety and wellbeing categories including physical wellbeing, mental wellbeing, and access to community essentials. The graphs also depict the benchmarking standard for the various community scores. In this manner, the user interface 1200 compares the community to the selected benchmark. In some embodiments, the system may calculate an average community scores for all communities, such averages may also be on a regional or national basis. The scorecard may include average community scores so that a community may compare its scores to national or regional averages.

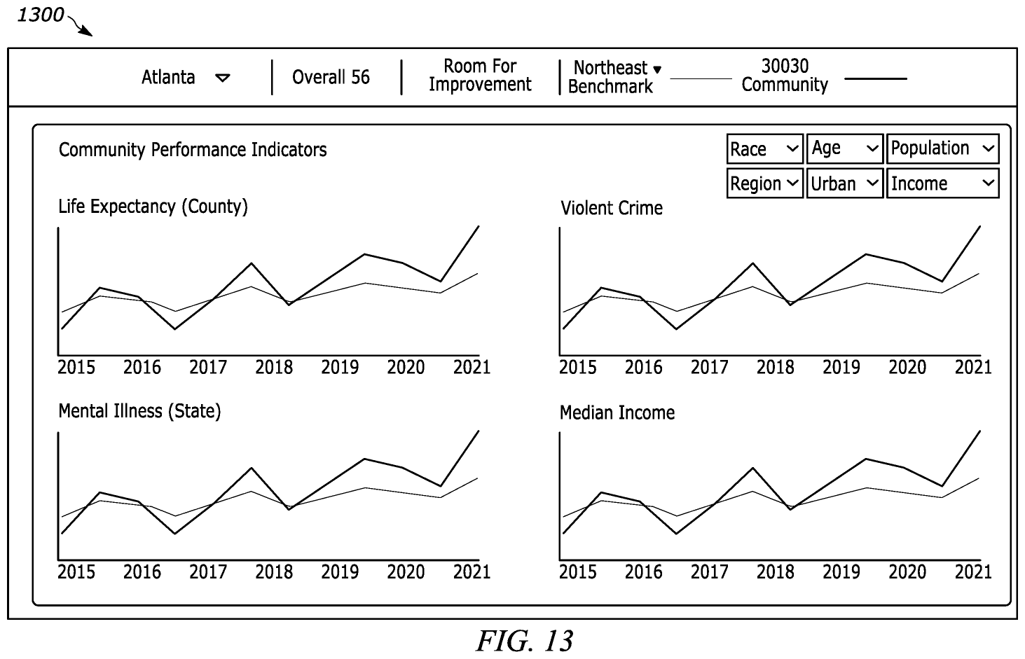

In FIG. 13, the user interface 1300 displays graphs depicting various forms of safety and wellbeing indicators associated with the community. The safety and wellbeing indicators displayed on the user interface 1300 include life expectancy, violent crime, mental illness, and median income. However, it is contemplated that other safety and wellbeing indicators may be displayed. The graphs also depict the safety and wellbeing indicators for a particular benchmark. As illustrated in FIG. 11, the benchmarking standard to which the community is compared may be selected via one or more filters.

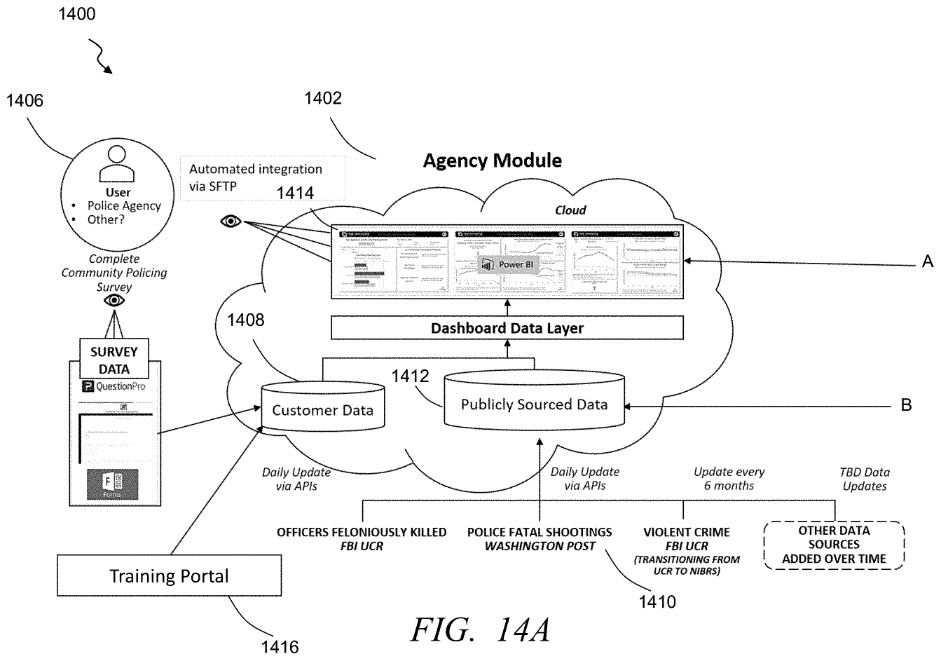

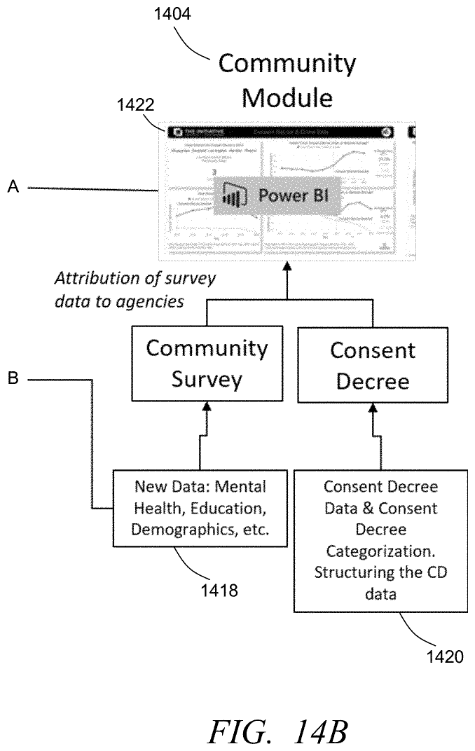

In some approaches, the performance evaluation system 100 may be operated to so that community evaluation occurs in conjunction with the institutional performance evaluation. In this manner, an institution can gauge its performance and perception based on input from or analysis of the community it serves or is otherwise associated with. One such application of the performance evaluation system 100 is illustrated with reference to FIGS. 14A and 14B.

Turning to FIGS. 14A and 14B, a performance evaluation system 1400 is illustrated which leverages both an agency evaluation module 1402 in conjunction with a community evaluation module 1404. Output from the community evaluation module 1404 is received by the agency evaluation module 1402. Such a system architecture allows for an interface between an institution and the community it serves. In this manner, an institution may receive feedback from or data on the community it serves to see how its performance impacts the community and community safety and wellbeing or related metrics. Further, using system 1400 a community may provide feedback and the institution may assess its own performance in a confidential manner.

In particular, the performance evaluation system 1400 is structured to collect data related to the performance of a police agency. Specifically, the system 1400 collects data related to the agency's ability to engage in community policing and the impact of community policing on the community served by the police agency. However, the performance evaluation system 1400 or similar architectures may be employed with other institutions.

The agency module 1402 receives data from a questionnaire or survey module 1406. Through the agency survey module 1406, a user completes an electronic survey that includes, for example, questions related to policing performance or, in particular, to community policing. The user may be any individual associated with the police agency, such as a police chief or officer. The agency survey module 1406 presents community policing survey questions to the user via a graphical user interface. In response, the user enters responses to the survey questions via the user interface. Once the community policing survey is complete, the survey data is transmitted to a customer database 1404. The survey data is associated with the particular police agency in the customer database 1404. In some embodiments, the customer database 1404 is equipped with row-level security so that the police agency only has access to its own data.

The agency module 1402 also receives data from a number of additional public data sources 1404 via a number of Application Programming Interfaces (APIs). The publicly available data sources 1404 that are mined by the agency module include, e.g., the FBI UCR and Washington Post databases. For example, the agency module 1402 may collect data on violent crime and the number of officers feloniously killed from the FBI UCR database. In another example, the agency module 1402 may collect data on the number of fatal police shootings from the Washington Post database. The APIs may collect data from the public data sources 1404 in real-time or at periodic intervals, for example, daily, monthly, semi-annually, or annually. The frequency at which data is collected from public data sources 1404 may depend on a number of factors, such as how often the data sources are updated or how often police agency evaluation occurs. Data gathered from the public data sources 1404 is stored in the publicly sourced database 1412.

It is contemplated that data from the public data sources 1404 may be categorized or tagged in the database 1412 in various ways. For example, the data may be categorized using regional boundaries, for example by state, region, zip code, county, etc. In this manner, data categorization may allow the data to be more easily associated with a particular police agency.

The survey data stored in the customer database 1408 and public data (e.g., officers feloniously killed, fatal police shootings, violent crime data) stored in the publicly sourced database 1412 is analyzed and merged to generate a dashboard 1414 for a particular police agency. The dashboard 1414 may be presented to a user associated with the police agency via a graphical user interface.

As part of the data analysis to generate the dashboard 1414, the agency module 1402 calculates one or more performance scores, such as community policing scores, for the police agency based on survey data stored in the customer database 1408. The performance scores for the police agency or displayed via the police agency's dashboard 1414. Further, the dashboard consolidates data from the publicly sourced database 1412 that is associated with the particular police agency undergoing evaluation. Accordingly, the police agency's dashboard 1414 may also display the publicly available data for the agency, such as officers feloniously killed, fatal police shootings, and violent crime data associated with the agency. In this manner, the dashboard 1414 allows the police agency to view both community policing scores and other publicly available metrics to assess its performance.

The community evaluation module 1404 also receives data from a number of sources. The community module 1404 receives data from a community survey module 1418. Through the community survey module 1418, a user associated with the community completes an electronic survey that includes, for example, questions related to mental health, physical health, demographics, access to resources, etc. In some approaches, the electronic survey may be sent to any person associated with the community. In some embodiments, the electronic survey may be sent to any individual associated with a particular zip code. The community survey module 1418 presents survey questions to the user via a graphical user interface. In response, the user enters responses to the survey questions via the user interface. Once the community survey is complete, the community survey data may be transmitted to a database. The community evaluation module 1404 may include one or more algorithms that may attribute community survey data to particular police agencies. For example, the community survey data may be linked to a particular region, state, county, zip code, city, township, etc. so that the data may be attributed to a particular police agency. In this manner, a police agency may be able to access community survey data via the agency module 1404.

The community evaluation module 1404 may also receive consent decree data via a consent decree module 1420. The consent decree data may be collected directly from legal documents such as consent decrees. The consent decree data may also be sourced from one or more publicly available data sources that track data on police agencies that are governed by consent decrees. Consent decree data may be in an unstructured format and, accordingly, may be structured and/or categorized either manually or via the community evaluation module 1404. The consent decree data may include the police agencies, communities, or other geographic areas that are governed by the consent decree. The consent decree data may also include the time frame that the consent decree is in effect. The consent decree data may also indicate specific policies or measures implemented as part of the consent decree.

It is also contemplated that the consent decree module 1420 may associate crime statistics or other community performance metrics such as violent crime rate, fatal police shootings, officers feloniously killed, etc. with consent decree data. For example, the consent decree module 1420 may track the violent crime rate, fatal police shootings, and/or officers feloniously killed for a police agency or city before, during, and after a consent decree is in effect. Further, the consent decree module 1420 may compare crime statistics or other community performance metrics for police agencies, communities, or other geographic areas that are subject to consent decrees to those that are not subject to a consent decrees or to national averages. For example, the consent decree module 1420 may compare the number of law enforcement officers feloniously killed, the violent crime rate, the property crime rate, and the number of fatal shootings by police for consent decree cities to the national averages. In some embodiments, the consent decree module 1420 may also analyze the specific policies or measures implemented as part of a consent decree. For example, the consent decree module 1420 may assess the impact of various consent decree policies on outcomes such as the number of law enforcement officers feloniously killed, the violent crime rate, the property crime rate, and the number of fatal shootings by police. In another example, the consent decree module 1420 may assess the impact of consent decree policies using community survey data. In one approach, the consent decree module 1420 may analyze how mental health, physical health, access to resources, etc. in the community change after implementation of a consent decree or a consent decree policy.

In addition to collecting data via the community survey module 1418 and the consent decree module 1420, the community module 1404 may also receive data from any one of the public data sources 1410 discussed with reference to the agency evaluation module 1402. The community survey module 1418 may also receive data from the publicly sourced database 1412.

The community evaluation module 1404 analyzes and merges the community survey data, the consent decree data, and other public data (e.g., officers feloniously killed, fatal police shootings, violent crime data, etc.) to generate a dashboard 1422 for a particular community. The community dashboard 1422 may be presented to a user associated with the community via a graphical user interface. In some embodiments, the community dashboard 1422 may be accessed via the agency module 1402. In this manner, a user associated with a police agency may be able to access the community dashboard 1422 to view the community evaluation data.

As part of the data analysis to generate the dashboard 1422, the community evaluation module 1404 calculates one or more safety and wellbeing scores for the community based on the community survey data. In some approaches, the safety and wellbeing scores may be indicative of the community's mental health or wellbeing, physical health or wellbeing, educational opportunities, employment opportunities, access to resources, etc. The safety and wellbeing scores for the community may be displayed via the community dashboard 1422. Further, the dashboard 1422 may also display the publicly available data for the community, such as fatal police shootings, property crime data, and violent crime data associated with the community. In this manner, the dashboard 1422 allows a user to view both community safety and wellbeing scores and other publicly available metrics to assess the safety and wellbeing of the community.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A method of evaluating policing performance of an agency, the method comprising:
transmitting a first electronic community policing questionnaire to at least one electronic device;
receiving a first set of data indicative of one or more policing metrics;
assigning weight to the data indicative of one or more policing metrics;
calculating at least one community policing score based on the weight assigned to the data indicative of one or more policing metrics;
automatically associating at least one corrective action with the agency based on the at least one community policing score.

2. The method of claim 1, further comprising:
automatically transmitting at least one recommendation to an electronic device associated with the agency based on the at least one community policing score.

3. The method of claim 1, further comprising:
automatically transmitting at least one electronic training program to an electronic device associated with the agency based on the at least one community policing score.

4. The method of claim 1, wherein the method further comprises:
creating a confidential account for a user associated with the agency; and
transmitting the electronic community policing questionnaire to the confidential account.

5. The method of claim 1, wherein the method further comprises:
assigning a certification level to the agency based on the at least one calculated community policing score.

6. The method of claim 1, wherein the method further comprises:
generating an electronic scorecard for the agency based on the at least one community policing score; and
transmitting the electronic scorecard to at least one electronic device.

7. The method of claim 1, wherein the data indicative one or more policing metrics includes at least one of: community engagement data, officer training data, and organizational development data.

8. The method of claim 1 further comprising:
receiving policing metric data associated with the agency from at least one database;
receiving regional policing metric data from at least one database; and
comparing the policing the policing metric data associated with the agency to the regional policing metric data.

9. The method of claim 8, wherein the policing metric data associated with the agency and the regional policing metric data includes at least one of: a number of assaults against officers, a number of citizen complaints, a number of police misconduct lawsuits, a number of use of force incidents, and a number of service calls.

10. The method of claim 1 further comprising:
receiving crime data associated with the agency from at least one database;
receiving regional crime data from at least one database; and
comparing the crime data associated with the agency to the regional crime data.

11. The method of claim 10, wherein the crime data associated with the agency and the regional crime data include at least one of: a number of fatal shootings by police, a number of law enforcement officers killed, a number of violent crime incidents, a number of property crime incidents.

12. The method of claim 10 further comprising:
automatically associating at least one corrective action with the agency based on the comparison the crime data associated with the agency to the regional crime data.

13. The method of claim 1 further comprising:
receiving unstructured consent decree data associated with an agency subject to a consent decree;
extracting at least one corrective action from the unstructured consent decree data;
calculating a community policing score for the agency subject to the consent decree; and
recommending the at least one corrective action to other agencies with similar community policing scores.

14. The method of claim 1 further comprising:
transmitting a second electronic questionnaire to at least one electronic device;
in response to transmitting the second electronic community policing questionnaire, receiving second set of data indicative of one or more policing metrics and receiving data indicative of the at least one corrective action;
assessing the effectiveness of the at least one corrective action based on a comparison of the first set of data and the second set of data indicative of one or more policing metrics.

15. An institution performance evaluation system comprising:
at least one electronic device including a user interface;
at least one database housing crime data and policing metric data;
at least one processor communicable with the at least one electronic device and the at least one database, the at least one processor configured to:
identify a police agency;
transmit an electronic questionnaire to a user associated with the police agency via the electronic device;
in response to the electronic questionnaire, receive data indicative of one or more policing metrics;
calculate a community policing score based on the data indicative of one or more policing metrics;
query the at least one database to determine crime data associated with the police agency;
query the at least one database to determine crime associated with a particular region;
compare the crime data associated with the police agency and the crime data associated with the particular region; and
generate an electronic scorecard based on the calculated community policing score and the comparison.

16. The system of claim 15, wherein the at least one processor is further configured to: automatically associate at least one corrective action with the police agency based on at least one of the community policing score and the comparison.

17. The system of claim 15, wherein the at least one processor is further configured to: query the at least one database to determine policing metric data associated with the police agency and to determine policing metric data associated with the particular region; and compare the policing metric data associated with the police agency and the policing metric data associated with the particular region.

18. A community evaluation system comprising:
at least one electronic device including a user interface;
at least one database housing performance indicator data that is indicative of the overall safety and wellbeing of a community;
at least one processor communicable with the at least one electronic device and the at least one database, the at least one processor configured to:
identify a first community;
transmit an electronic questionnaire to an individual associated with the first community via the electronic device;
in response to the electronic questionnaire, receive data indicative of at least one of public safety, physical health, mental health, economic opportunities, and educational opportunities associated with the first community;
calculate a community score associated with the first community based on the received data;
query the at least one database to determine performance indicator data associated with the first community;
query the at least one database to determine performance indicator data associated with a particular region; and
compare the performance indicator data associated with the first community to the performance indicator data associated with the particular region; and
generate an electronic scorecard for the first community based on at least one of the calculated community score and the comparison.

19. The system of claim 18, wherein the at least one processor is further configured to weight the data indicative of at least one of public safety, physical health, mental health, economic opportunities, and educational opportunities associated with the community to calculate the community score.

20. The system of claim 18, wherein the at least one processor is further configured to:
identify a second community;
transmit a second electronic questionnaire to an individual associated with the community via an electronic device;
in response to the second electronic questionnaire, receive data indicative of at least one of public safety, physical health, mental health, economic opportunities, and educational opportunities associated with the second community;
calculate a community score associated with the second community based on the received data; and
rank the first and second community based on the community score associate with the first community and the community score associated with the second community.

21. The system of claim 18, wherein the at least one processor is further configured to:
identify at least one corrective action implemented by a police agency associated with the community; and
assess the impact of the at least one corrective action based on the calculated community score.

22. An institution performance evaluation system:
at least one electronic device including a user interface;
at least one database housing incident data indicative of one or more incidents associated with an institution, a region, or a community;
at least one processor communicable with the at least one electronic device and the at least one database, the at least one processor configured to:
identify a particular institution;
transmit an electronic questionnaire to a user associated with the particular institution via the electronic device;
in response to the electronic questionnaire, receive data indicative of one or more institutional metrics;
calculate a performance score for the particular institution based on the data indicative of one or more institutional metrics;
query the at least one database to determine incident data associated with the particular institution;
query the at least one database to determine incident data associated with a particular region;
compare the incident data associated with the particular institution and the incident data associated with the particular region; and
generate an electronic scorecard based on the calculated performance score and the comparison.

23. The system of claim 22, wherein the at least one processor is further configured To automatically generate a recommendation for the institution based on the calculated performance score.

24. The system of claim 22, wherein at least one of the incident data, the data indicative of one or more institutional metrics, and the calculated performance score are updated in real-time.
